(19) United States
(12) Patent Application Publication
(10) Pub. No.: US 2024/0003639 A1
(43) Pub. Date: Jan. 4, 2024

(54) COOLER WITH TWO SUBSTANTIALLY PARALLEL FLOW CHAMBERS AND THREE SUBSTANTIALLY PARALLEL PLATES

(71) Applicant: Hanon Systems, Daejeon (KR)

(72) Inventors: Florian Bieregger, München (DE); David Rochholz, Köln (DE); Igor Kindt, Alfter (DE)

(21) Appl. No.: 18/248,471

(22) PCT Filed: Feb. 21, 2022
(86) PCT No.: PCT/KR2022/002541

§ 371 Date: Apr. 10, 2023

(30) Foreign Application Priority Data
Mar. 11, 2021 (DE) 10 2021 105 930.5
Sep. 28, 2021 (DE) 10 2021 210 826.1

(51) Int. Cl. F28F 3/12

(52) U.S. Cl. CPC F28F 3/12

(57) ABSTRACT

A cooler includes two substantially parallel flow chambers and three substantially parallel plates, two of the plates forming a substantially planar structure at the outer sides of the cooler, and the intermediate plate, which is interposed between the two planar plates, being shaped such that a fluid flow is divided into a plurality of flows after entering the cooler, which preferably actively flows on one of the two sides of the cooler but always flows on both sides simultaneously.

### CROSS REFERENCE TO RELATED PATENT APPLICATIONS

This is a U.S. national phase patent application of PCT/KR2022/002541 filed Feb. 21, 2022 which claims the benefit of and priority to German Patent Application No. 10 2021 210 826.1 filed on Sep. 28, 2021 and German Patent Application No. 10 2021 105 930.5 filed on Mar. 11, 2021, the entire contents of each of which are incorporated herein by reference.

### TECHNICAL FIELD

The invention relates to a cooler with two substantially parallel flow chambers and three substantially parallel plates.

### BACKGROUND ART

Conventional battery coolers comprise two substantially parallel plates, one of which is essentially planar and provided to be in direct contact with a battery module in order to cool said module. The other plate usually defines the flow channels for coolants or refrigerants and is mechanically joined, usually soldered, to the first-mentioned plate. More than one inlet may furthermore be provided in order to improve heat dissipation.

Against this background, the invention is based on the object of creating an improved cooler for battery modules.

### SUMMARY

This object is solved as disclosed herein.

According thereto, it comprises two substantially parallel flow chambers and three substantially parallel plates, of which the two outer plates form a substantially planar structure at least at the outer side so as to be in good direct contact with the battery modules to be cooled.

The cooler furthermore comprises an intermediate plate between the two aforementioned plates, which is formed such that a fluid flow is divided into a plurality of flows after entering the cooler, preferably immediately or directly after the inlet, in other words in the vicinity of the inlet. A flow is hereby always provided on both sides of the cooler, in other words in both of the parallel flow chambers, but an active flow may preferably be provided on one of the two sides of the cooler.

Owing to the two parallel flow chambers, one or more battery modules may to some extent be arranged on both sides of the cooler such that the packing density within a battery housing can be increased. The intermediate plate, which, according to the invention, usually defines the flow channels, may thus essentially be used for both flow chambers such that an efficient structure is ensured. At the same time, heat dissipation can be ensured, and the cooler according to the invention has good adaptability to different types and numbers of battery modules. For the sake of completeness, it is mentioned that the three plates are mechanically connected to each other in a suitable manner, in particular soldered, so that a cooler with high strength is overall obtained. This concerns both the resistance to internal pressure and also to external mechanical stress, which can occur, for example, during connection to battery modules in the course of assembly. Owing to the quasi two-layer configuration of the cooler, both sides of the cooler can be provided with suitable flow channels, and the temperature distribution and heat dissipation can be optimized on both sides of the cooler. At the same time, as will be explained in more detail below, the measures for dividing the flow between the two parallel flow chambers can be provided in a simple manner by means of simple structures.

For the sake of completeness, it is mentioned that a filler material may be provided between the cooler and at least one battery module for possible unavoidable gaps that may occur as a result of tolerances. The cooler may furthermore be connected to the cooling system of a vehicle. The cooler according to the invention moreover exhibits low pressure loss, as mentioned, high strength and low temperature differences in the region of the outer surfaces of the cooler.

The cooler therefore advantageously meets the requirements regarding the resistance to stress such as vibrations or module assembly. These can be adapted according to system and customer requirements.

As regards the structures and geometries that are formed in the intermediate plate in order to cause the described the flow division, round holes, elongated holes, slits and/or suitable stamping geometries are currently preferred. These can be introduced into the plate in an efficient manner during the forming process, and can be respectively adapted to parameters such as output, mass flow, fluid type, and the like.

At least one outer plate preferably comprises at least one inlet and/or outlet. This essentially provides a means of connection to the fluid system of a vehicle and can be designed independently of the respectively used sealing and connector concept. In principle, a connection may be formed on both sides of the cooler and on each of the three plates.

At the same time, the thickness of at least one plate can advantageously be reduced to 0.5 mm or less without reducing the strength too much. Depending on the manufacturing process and the respective requirements, the plate thicknesses may differ from each other.

As regards the flow geometry, initial simulations have shown a meandering and/or U shape to be advantageous. The meanders may be comparatively complex and thus particularly adapted to the requirements.

As regards the mechanical internal pressure resistance of the cooler, it is currently preferred for it to be resistant to an internal pressure corresponding to the maximum operating pressure of conventional refrigerants (R134a and R1234yf) in order to form a particularly stable cooler. This value can in particular be achieved by minimizing free spanned areas between the plates by connecting the plates to each other at a plurality of points and/or parallel to a plurality of flow channels. The internal pressure resistance can then be ensured despite plate thicknesses of 0.5 mm or less.

Depending on requirements, the intermediate plate may either be completely flush with the planar plates or may be offset inwardly on at least one side.

A coolant cooler and a direct refrigerant evaporator are currently preferred fields of use for the cooler according to the invention.

As regards the plate thicknesses already mentioned above, a minimum ratio of less than 55% is currently preferred between a plate thickness of the intermediate plate and that of at least one outer plate. However, three plates of the same thickness or plates with thickness ratios of greater than 55% may also be used.

The channel design according to the invention furthermore advantageously enables a ratio between a channel width and a plate thickness to be greater than nine.

### BRIEF DESCRIPTION OF DRAWINGS

In the following, the invention will be explained in more detail by means of example embodiments. The drawings show the following:

FIG. 1 shows the basic structure of the cooler according to the invention,

FIG. 2 shows a combination of the cooler according to the invention with two battery modules,

FIG. 3 shows a detail of the cooler according to the invention,

FIG. 4 shows a further detail of the cooler according to the invention, and

FIG. 5 shows alternative configurations of the cooler according to the invention.

### DESCRIPTION OF AN EMBODIMENT

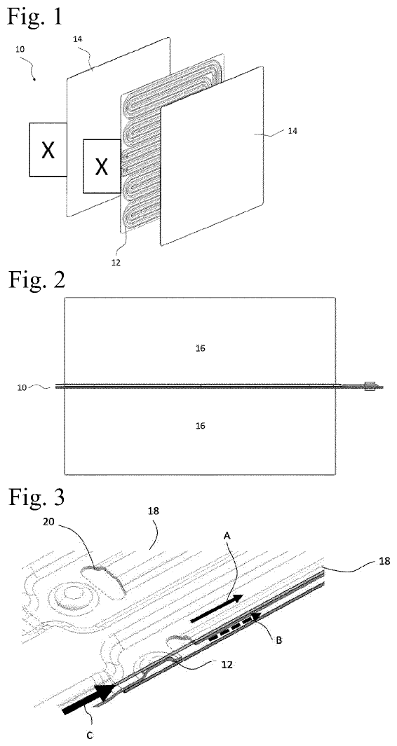

As is apparent from FIG. 1, the cooler 10 according to the invention essentially consists of one intermediate plate 12 and two outer plates 14. All plates are typically substantially rectangular, and the outer plates 14 are substantially planar, at least on the outer sides thereof. The intermediate plate 12 comprises structures that will be described in more detail below for forming flow channels on both sides of the intermediate plate 12, in other words towards both outer plates 14. In the case shown, the intermediate plate and the rear outer plate in the figure furthermore comprise an inlet and an outlet, designated as X, which will also be described in more detail below and which can be adapted to customer specifications.

As shown in FIG. 2, the cooler 10 according to the invention may be arranged in a sandwich-like manner between two battery modules 16 and can efficiently cool them in an advantageous manner.

FIG. 3 shows a detailed view of how ribs 18 are formed on the intermediate plate 12 in order to delimit individual flow channels from each other, and how a slit 20 is formed in the shown example at one upstream end of the respective rib 18 in order to divide the inflowing coolant indicated by the arrow C into a coolant flow A on the side facing the viewer and into a coolant flow B on the side facing away from the viewer. As will be explained in more detail below, the slits 20, which in the shown case are formed substantially transverse to the flow direction, may also be oriented at a different angle, or be oriented substantially parallel to the flow direction, or may be configured as openings without any noteworthy longitudinal extension. Furthermore, one or more openings that enable coolant flow to the other side of the plate may be provided in the intermediate plate 12 instead of or in addition to the slits at the start of the ribs 18.

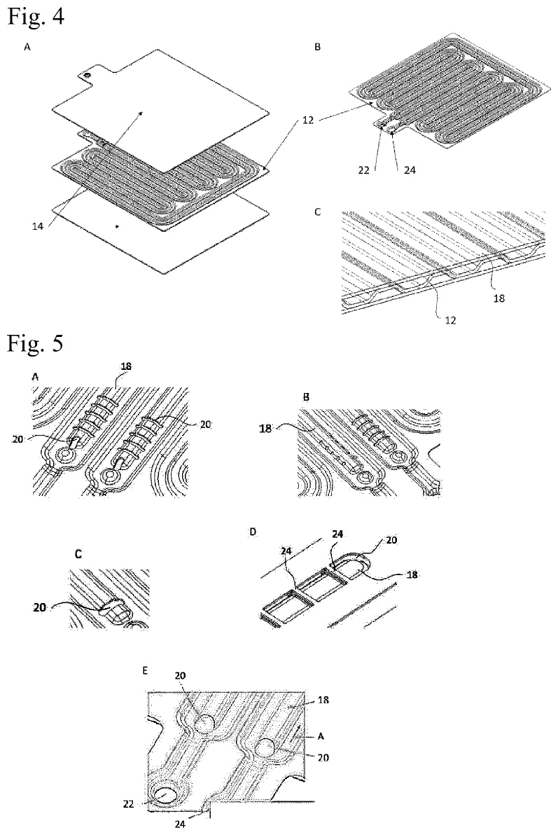

FIG. 4 essentially corresponds to FIG. 1, the flow channels being provided with additional meanders, and the inlet 22 and outlet 24 of the cooler being shown in more detail in FIG. 4B in the shape of largely circular openings. As is apparent from the top left of FIG. 4A, the outlet can, for example, be provided in the upper outer plate of the figure and the inlet can be provided in the other outer plate. It is apparent from FIG. 4C how the intermediate plate 12 provided with the ribs 18 in combination with the outer plates 14 attached thereto defines flow channels that are parallel to each other.

It is shown in FIG. 5A how a slit 20 at the start of a rib 18 can be oriented substantially parallel to the flow direction, and how the rib 18 can be provided over its further course with slits 20 extending transverse to the flow direction. Both the slit 20 that is parallel to the flow direction as well as one or more transverse slits 20 may be omitted, leaving only one or more transverse slits 20 or the slit 20 parallel to the flow direction.

As is in particular apparent from the area on the left of FIG. 5B, one or more such slits 20 may also be formed as openings without a noteworthy longitudinal extension, in particular as circular openings and in pairs at corresponding locations along the longitudinal extension of the rib 18 and/or on the side thereof. A larger, substantially circular opening may also be provided at the start of the rib, similar to the slit 20 shown in FIG. 3 and/or the inlet 22 and outlet 24 shown in FIG. 4B.

This is shown in FIG. 5E, in which an inlet 22 and an outlet 24 are moreover shown. As is apparent from FIG. 5E, there is a comparatively large opening 20 at the start of the rib 18, and it essentially has the same width as the rib 18. The shown opening 20 is overall substantially circular. “A” indicates the coolant flow next to the rib 18.

As is apparent in FIG. 5C, one or more slits that are essentially transverse to the flow direction may also be wider than shown in FIG. 5A and may thus be essentially formed as an elongated hole. Finally, FIG. 5D shows an embodiment in which a rib 18 is connected to the surrounding plate material by means of individual steps or bridges 24 such that a slit 20 is formed, so to speak, around the rib 18, which slit is interrupted only by the bridges 24, and substantially one U-shaped end of which is apparent in FIG. 5D.

As is clearly apparent from FIGS. 1 and 4, for example, the ribs may be substantially straight so as to delimit a plurality of flow channels from each other that are substantially parallel to each other in sections.

1-10. (canceled)

11. A cooler with two substantially parallel flow chambers, the cooler comprising three substantially parallel plates, two of the plates forming a substantially planar structure at outer sides of the cooler, and an intermediate one of the plates, which is interposed between the two of the plates, being shaped such that a flow of a fluid is divided into a plurality of flows after entering the cooler, which always flows on both sides of the cooler simultaneously.

12. The cooler according to claim 11, wherein the intermediate plate comprises round holes, elongated holes, slits and/or stamping geometries.

13. The cooler according to claim 11, wherein at least one of the two of the plates comprises at least one inlet and/or outlet.

14. The cooler according to claim 11, wherein at least one of the plates has a thickness of up to 0.5 mm.

15. The cooler according to claim 11, wherein the fluid is guided through the cooler in a meandering and/or U shape.

16. The cooler according to claim 11, wherein the cooler has a mechanical internal pressure resistance corresponding to a maximum operating pressure of conventional refrigerants.

17. The cooler according to claim 11, wherein the intermediate plate is either completely flush with the two of the plates or is offset inwardly on at least one side.

18. The cooler according to claim 11, wherein the cooler is provided as a coolant cooler or as a direct refrigerant evaporator for refrigerants.

19. The cooler according to claim 11, wherein a minimum ratio between a plate thickness of the intermediate plate and that of at least one of the two of the plates is less than 55%.

20. The cooler according to claim 11, wherein a ratio between a channel width and a thickness of one of the plates is greater than nine.
